(19) United States
(12) Patent Application Publication
(10) Pub. No.: US 2025/0149214 A1
(43) Pub. Date: May 8, 2025

(54) MAGNETORHEOLOGICAL ELASTOMER COMPOSITION AND METHOD FOR PRODUCING THE SAME

(71) Applicant: Murata Manufacturing Co., Ltd., Nagaokakyo-shi (JP)

(72) Inventor: Kano HYOUI, Nagaokakyo-shi (JP)

(21) Appl. No.: 19/014,563

(22) Filed: Jan. 9, 2025

Related U.S. Application Data
(63) Continuation of application No. PCT/JP2023/017760, filed on May 11, 2023.

(30) Foreign Application Priority Data
Jul. 12, 2022 (JP) 2022-111738

(51) Int. Cl. H01F 1/44; C08G 18/48; C08G 18/76; C08K 3/08; C08K 5/12

(52) U.S. Cl. CPC H01F 1/447; C08G 18/4812; C08G 18/4825; C08G 18/4829; C08G 18/7614; C08K 3/08; C08K 5/12; C08K 2003/0856; C08K 2201/01

(57) ABSTRACT

A magnetorheological elastomer composition that includes: a resin (A); a magnetic powder (B); and a plasticizer (C). The resin (A) contains a urethane resin (A1) having an average inter-crosslinking point molecular weight of 9,500 to 27,000, and the urethane resin (A1) contains a reaction product of a polyol (x) and a polyisocyanate (y). The polyol (x) contains a triol (x1) having a number-average molecular weight of 4,000 or more.

### CROSS REFERENCE TO RELATED APPLICATIONS

The present application is a continuation of International application No. PCT/JP2023/017760, filed May 11, 2023, which claims priority to Japanese Patent Application No. 2022-111738, filed Jul. 12, 2022, the entire contents of each of which are incorporated herein by reference.

### TECHNICAL FIELD

The present disclosure relates to a magnetorheological elastomer composition.

### BACKGROUND ART

As a material that can be used for a vibration-proof/damping material or an energy transfer material, a magnetically responsive material in which a magnetic substance is dispersed in a resin material is known.

As such a magnetically responsive material, Patent Document 1 discloses a polyurethane elastomer composition containing a reaction product of a polyol compound and a polyisocyanate compound and magnetic particles, and discloses use of a propylene oxide adduct of bisphenol A as the polyol compound.

Patent Document 1: Japanese Patent Application Laid-Open No. 2019-210311

### SUMMARY OF THE DISCLOSURE

In the polyurethane elastomer composition disclosed in Patent Document 1, the change in the storage elastic modulus when a magnetic field is applied is not sufficiently satisfactory as compared with the storage elastic modulus when a magnetic field is not applied.

An object of the present disclosure is to provide a magnetorheological elastomer composition showing a large change in storage elastic modulus when a magnetic field is applied with respect to the storage elastic modulus when a magnetic field is not applied.

A magnetorheological elastomer composition of the present disclosure includes: a resin (A); a magnetic powder (B); and a plasticizer (C). The resin (A) contains a urethane resin (A1) having an average inter-crosslinking point molecular weight of 9,500 to 27,000, and the urethane resin (A1) contains a reaction product of a polyol (x) and a polyisocyanate (y). The polyol (x) contains a triol (x1) having a number-average molecular weight of 4,000 or more.

The present disclosure can provide a magnetorheological elastomer composition showing a large change in storage elastic modulus when a magnetic field is applied with respect to the storage elastic modulus when a magnetic field is not applied.

### DESCRIPTION OF THE PREFERRED EMBODIMENTS

A magnetorheological elastomer composition of the present disclosure includes: a resin (A); a magnetic powder (B); and a plasticizer (C). The resin (A) contains a urethane resin (A1) having an average inter-crosslinking point molecular weight of 9,500 to 27,000, and the urethane resin (A1) contains a reaction product of a polyol (x) and a polyisocyanate (y). The polyol (x) contains a triol (x1) having a number-average molecular weight of 4,000 or more.

The magnetorheological elastomer composition of the present disclosure shows a large change in storage elastic modulus when a magnetic field is applied with respect to the storage elastic modulus when a magnetic field is not applied. That is, for the magnetorheological elastomer composition of the present disclosure, the elastic modulus measured under a magnetic field shows a large change rate (hereinafter also referred to as “rate of change in elastic modulus under magnetic field”) with respect to the elastic modulus measured under the condition of a magnetic field strength of 0 A/m (hereinafter also referred to as “under zero magnetic field”). Although not to be construed as being limited to a specific theory, a viscoelastic elastomer can be understood as a material having both elasticity and viscosity. It is then considered that the elasticity may be derived from the crosslinking point (branch point) and the viscosity may be derived from the molecular chain between two adjacent crosslinking points. Since the magnetorheological elastomer composition of the present disclosure contains the urethane resin (A1) using the triol (x1) having a certain number-average molecular weight or more as a raw material, crosslinking points are introduced into the magnetorheological elastomer composition by the triol (x1), and the molecular weight of the molecular chains bonded to the crosslinking points is controlled to a certain value or more. Therefore, it is considered that when a magnetic field is applied, the orientation of the magnetic powder (B) contained in the magnetorheological elastomer composition can be changed without restriction, and a good change in elastic modulus can be obtained.

In the present disclosure, the viscoelastic elastomer means a material having both viscosity and elasticity and can be distinguished on the basis of the relaxation time of stress relaxation (change in stress with time) when a certain strain is applied. When the relaxation time is sufficiently short with respect to the time scale of observation, it is understood as a viscous body, when the relaxation time is long, it is understood as an elastic body, and when the relaxation time is on an equivalent scale, it is understood as a viscoelastic body.

In addition, in the present disclosure, the magnetorheological elastomer represents a viscoelastic elastomer containing magnetic particles and preferably represents a composite material in which the magnetic particles are dispersed and fixed in the viscoelastic elastomer. The apparent elastic modulus and attenuation characteristics of the magnetorheological elastomer reversibly change in response to an external magnetic field.

In the present disclosure, the magnetorheological elastomer means a viscoelastic elastomer containing a magnetic powder. Assuming that the storage elastic modulus measured at a magnetic field strength of 0 A/m is G′₀, and the storage elastic modulus measured at a magnetic field strength of more than 0 A/m so that the direction of the magnetic field and the rotation axis of a rotational viscoelastometer are parallel to each other is G′₁, the magnetorheological elastomer can be understood as a material in which G′₁ is at least more than G′₀.

### [Resin (A)]

The resin (A) contains the urethane resin (A1).

### [Urethane Resin (A1)]

The urethane resin (A1) contains the reaction product of the polyol (x) and the polyisocyanate (y). When a hydroxy group contained in the polyol (x) and an isocyanate group contained in the polyisocyanate (y) react with each other, a urethane bond can be formed to form a urethane resin. The urethane resin (A1) may be a reaction product of the reaction product of the polyol (x) and the polyisocyanate (y) and a chain extender (z1) and/or a terminator (z2), and these reaction products are all included in the technical scope of the urethane resin (A1).

The polyol (x) means a compound having two or more hydroxy groups in one molecule and includes the triol (x1) having a number-average molecular weight of 4,000 or more.

The triol (x1) has three hydroxy groups in one molecule. Since each hydroxy group contained in the triol (x1) reacts with an isocyanate group of a diisocyanate (y) described later to form a urethane bond, the triol (x1) includes a branch point (crosslinking point) in which three molecular chains are bonded to one atom.

The crosslinking point (branch point) in the triol (x1) can be introduced by a compound (initiator) having three or more active hydrogen atoms, and examples of the initiator include glycerin, trimethylolethane, trimethylolpropane, trimellitic acid, and diethylenetriamine.

The number-average molecular weight of the triol (x1) is 4,000 or more, preferably 4,000 to 15,000, more preferably 4,000 to 10,000, still more preferably 4,000 to 8,000. When the number-average molecular weight of the triol (x1) is within the above range, the molecular weight of the molecular chain bonded to the crosslinking point can be a certain value or more. As a result, it is considered that when the magnetic field strength is changed, the orientation of the magnetic powder (B) can be changed without restriction, and the change in elastic modulus of the magnetorheological elastomer composition is improved.

In the present disclosure, the number-average molecular weight can be measured as a converted value using polystyrene as a standard sample by gel permeation chromatography.

The triol (x1) may be, for example, a polyether triol, a polyester triol, a polycarbonate triol, a polyolefin triol, a polyacrylic triol, or the like, and is preferably a polyether triol.

The polyether triol can typically be understood as a triol of a polymer having as a repeating unit a unit including an ether bond, and the repeating unit preferably includes an oxyalkylene unit. Examples of the unit containing an ether bond include oxyalkylene units having two to four carbon atoms such as an oxyethylene unit, an oxypropylene unit, and an oxytetramethylene unit, and particularly include an oxypropylene unit and an oxytetramethylene unit. The polyether polyol may be a homopolymer containing one kind of oxyalkylene unit or a copolymer containing two or more kinds of oxyalkylene units. Examples of the polyether polyol include polyethylene triol, polypropylene triol, polytetramethylene ether triol, and polyoxyethylene-polyoxypropylene triol.

The oxyalkylene unit can be formed by ring-opening polymerization of a cyclic ether such as ethylene oxide, propylene oxide, and tetrahydrofuran.

The polyester triol can typically be understood as a triol of a polymer having as a repeating unit a unit including an ester bond. The unit including an ester bond can be formed by a reaction between a diol and a dicarboxylic acid or ring-opening polymerization of a cyclic ester compound. The polyester polyol may be a homopolymer containing one kind of repeating unit or a copolymer containing two or more kinds of repeating units.

As the diol as a raw material of the polyester triol, typically, a low molecular weight diol having a molecular weight of 50 to 300 may be used, and specific examples thereof include linear or branched aliphatic diols such as ethylene glycol, propylene glycol, 1,3-butanediol, 1,4-butanediol, neopentyl glycol, 1,6-hexanediol, 3-methylpentane-1,5-diol, diethylene glycol, triethylene glycol, dipropylene glycol, and tripropylene glycol; bisphenol compounds such as bisphenol A and bisphenol F; alkylene oxide adducts of the bisphenol compounds; and cycloaliphatic diols such as cyclohexanedimethanol. The alkylene oxide adducts of the bisphenol compounds can be formed by ring-opening polymerization of a cyclic ether with the bisphenol compound, and examples of the cyclic ether include ethylene oxide, propylene oxide, and tetrahydrofuran.

Examples of the dicarboxylic acid as a raw material of the polyester triol include aliphatic dicarboxylic acids such as succinic acid, adipic acid, sebacic acid, and dodecanedicarboxylic acid; aromatic dicarboxylic acids such as phthalic acid, isophthalic acid, terephthalic acid, and naphthalenedicarboxylic acid; anhydrides of the aliphatic dicarboxylic acids or the aromatic dicarboxylic acids; and esterified products of aliphatic dicarboxylic acids or aromatic dicarboxylic acids. The esterified products of the aliphatic dicarboxylic acids or the aromatic dicarboxylic acids can be formed by reacting an aliphatic dicarboxylic acid or an aromatic dicarboxylic acid with an alcohol, and examples of the alcohol include aliphatic alcohols having one to four carbon atoms such as methanol, ethanol, propanol, and butanol.

The polycarbonate triol can be understood as a triol of a polymer having as a repeating unit a unit including a carbonate bond (—O—CO—O—). The unit including a carbonate bond (—O—CO—O—) can be formed by a reaction between a carbonate ester and a diol, a reaction between phosgene and a diol, or the like. The polycarbonate polyol may be a homopolymer containing one kind of repeating unit or a copolymer containing two or more kinds of repeating units.

Examples of the carbonate ester as a raw material of the polycarbonate triol include methyl carbonate, dimethyl carbonate, ethyl carbonate, diethyl carbonate, cyclohexyl carbonate, dicyclohexyl carbonate, and diphenyl carbonate.

As the diol as a raw material of the polycarbonate triol, typically, a low molecular weight diol having a molecular weight of 50 to 300, or a high molecular weight diol having a number-average molecular weight of more than 300 may be used.

Examples of the low molecular weight diol include linear or branched aliphatic diols such as ethylene glycol, propylene glycol, 1,3-butanediol, 1,4-butanediol, neopentyl glycol, 1,6-hexanediol, 3-methylpentane-1,5-diol, diethylene glycol, triethylene glycol, dipropylene glycol, and tripropylene glycol; bisphenol compounds such as bisphenol A and bisphenol F; alkylene oxide adducts of the bisphenol compounds; and cycloaliphatic diols such as cyclohexanedimethanol. The alkylene oxide adducts of the bisphenol compounds can be formed by ring-opening polymerization of a cyclic ether with the bisphenol compound, and examples of the cyclic ether include ethylene oxide, propylene oxide, and tetrahydrofuran.

Examples of the high molecular weight diol include polyether diols such as polyethylene glycol and polypropylene glycol (diol); and polyester diols such as polyhexamethylene adipate. The number-average molecular weight of the high molecular weight diol is more than 300, preferably 400 to 5,000, more preferably 400 to 2,000.

The polyolefin triol can be understood as a triol of a polymer having as a repeating unit a unit composed of a divalent hydrocarbon group. The unit composed of a divalent hydrocarbon group can be formed by polymerization of an alkene or a diene. The polyolefin triol may be a homopolymer containing one kind of repeating unit or a copolymer containing two or more kinds of repeating units.

Examples of the alkene as a raw material of the polyolefin triol include ethylene, propylene, and isobutene, and examples of the diene as a raw material of the polyolefin triol include butadiene and isoprene.

The polyacrylic triol can be understood as a triol of a polymer having as a repeating unit a unit derived from a (meth)acrylic monomer. The polyacrylic triol may be a homopolymer containing one kind of repeating unit or a copolymer containing two or more kinds of repeating units.

The (meth)acrylic monomer may contain a (meth)acrylic monomer having a hydroxy group and another (meth)acrylic monomer and/or another vinyl monomer.

Examples of the (meth)acrylic monomer having a hydroxy group include hydroxyethyl (meth)acrylate, hydroxypropyl (meth)acrylate, and hydroxybutyl (meth)acrylate.

Examples of the other (meth)acrylic monomer include (meth)acrylate esters such as methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, nonyl (meth)acrylate, decyl (meth)acrylate, undecyl (meth)acrylate, and dodecyl (meth)acrylate; unsaturated carboxylic acids such as (meth)acrylic acid, maleic acid, and itaconic acid; and (meth)acrylamide monomers such as unsubstituted (meth)acrylamide, dimethyl (meth)acrylamide, N, N-methylenebis (meth)acrylamide, and diacetone (meth)acrylamide.

Examples of the other vinyl monomer include styrene and methylstyrene.

The content of the triol (x1) contained in the polyol (x) is, for example, 3 mass % or more, preferably 3 mass % to 70 mass %, more preferably 5 mass % to 60 mass %, still more preferably 7 mass % to 55 mass.

The polyol (x) preferably contains a diol (x2). The diol (x2) means a compound having two hydroxy groups in one molecule. By containing the diol as the polyol (x), it can be easier to control the molecular weight of the molecular chain bonded to the crosslinking point.

The diol (x2) may be a low molecular weight diol having a molecular weight of 50 to 300 or may be a high molecular weight diol having a number-average molecular weight of more than 300. In one aspect, a high molecular weight diol is preferable, and a polyether diol is more preferable.

Examples of the low molecular weight diol include linear or branched aliphatic diols such as ethylene glycol, propylene glycol, 1,3-butanediol, 1,4-butanediol, neopentyl glycol, 1,6-hexanediol, 3-methylpentane-1,5-diol, diethylene glycol, triethylene glycol, dipropylene glycol, and tripropylene glycol; bisphenol compounds such as bisphenol A and bisphenol F; cyclic ether adducts of the bisphenol compounds; and cycloaliphatic diols such as cyclohexanedimethanol. The alkylene oxide adducts of the bisphenol compounds can be formed by ring-opening polymerization of a cyclic ether with the bisphenol compound, and examples of the cyclic ether include ethylene oxide, propylene oxide, and tetrahydrofuran.

Examples of the high molecular weight diol include polyether diols, polyester diols, polycarbonate diols, polyolefin diols, and polyacrylic diols.

The polyether diol can typically be understood as a diol of a polymer having as a repeating unit the unit including an ether bond, and the repeating unit preferably includes an oxyalkylene unit. Examples of the oxyalkylene unit include oxyalkylene units having two to four carbon atoms such as an oxyethylene unit, an oxypropylene unit, and an oxytetramethylene unit, and particularly include an oxypropylene unit and an oxytetramethylene unit. The polyether polyol may be a homopolymer containing one kind of oxyalkylene unit or a copolymer containing two or more kinds of oxyalkylene units. Examples of the polyether polyol include polyethylene triol, polypropylene triol, polytetramethylene ether triol, and polyoxyethylene-polyoxypropylene triol.

The oxyalkylene unit can be formed by ring-opening polymerization of a cyclic ether such as ethylene oxide, propylene oxide, and tetrahydrofuran.

The polyester diol can typically be understood as a diol of a polymer having as a repeating unit the unit including an ester bond.

The polycarbonate diol can typically be understood as a diol of a polymer having as a repeating unit the unit including a carbonate bond (—O—CO—O—).

The polyolefin diol can typically be understood as a diol of a polymer having as a repeating unit the unit composed of a divalent hydrocarbon group.

The polyacrylic diol can typically be understood as a diol of a polymer having as a repeating unit the unit derived from a (meth)acrylic monomer.

The number-average molecular weight of the high molecular weight diol is more than 300, preferably 400 to 5,000, more preferably 400 to 3,000.

The content of the diol (x2) is preferably 50 parts by mass to 2,000 parts by mass, more preferably 60 parts by mass to 1, 500 parts by mass, still more preferably 70 parts by mass to 1,200 parts by mass with respect to 100 parts by mass of the triol (x1).

In a preferred aspect, the polyol (x) includes the triol (x1) and the diol (x2). The total content of the triol (x1) and the diol (x2) in 100 mass % of the polyol (x) is, for example, 80 mass % to 100 mass %, preferably 90 mass % to 100 mass %, more preferably 95 mass % to 100 mass %.

The polyol (x) may contain another polyol (x3) in addition to the triol (x1) and the diol (x2). The other polyol (x3) can include a triol having a molecular weight of less than 4,000, a triol having 4 or more hydroxy groups in one molecule, and the like.

The polyisocyanate (y) represents a compound having two or more isocyanate groups in one molecule. The number of isocyanate groups contained in one molecule of the polyisocyanate (y) is typically two to four, and may be particularly two or three.

Examples of the polyisocyanate (y) include aliphatic polyisocyanates, aromatic polyisocyanates, and cycloaliphatic polyisocyanates.

Examples of the aliphatic polyisocyanates include tetramethylene diisocyanate, 1,6-hexamethylene diisocyanate, dodecamethylene diisocyanate, and trimethylhexamethylene diisocyanate.

Examples of the aromatic polyisocyanates include 1,3- and 1,4-phenylene diisocyanate, 1-methyl-2,4-phenylene diisocyanate, 1-methyl-2,6-phenylene diisocyanate, 1-methyl-2,5-phenylene diisocyanate, 1-methyl-2,6-phenylene diisocyanate, 1-methyl-3,5-phenylene diisocyanate, 1-ethyl-2,4-phenylene diisocyanate, 1-isopropyl-2,4-phenylene diisocyanate, 1,3-dimethyl-2,4-phenylene diisocyanate, 1,3-dimethyl-4,6-phenylene diisocyanate, 1,4-dimethyl-2,5-phenylene diisocyanate, diethylbenzene diisocyanate, diisopropylbenzene diisocyanate, 1-methyl-3,5-diethylbenzene diisocyanate, 3-methyl-1,5-diethylbenzene-2,4-diisocyanate, 1,3,5-triethylbenzene-2,4-diisocyanate, naphthalene-1,4-diisocyanate, naphthalene-1,5-diisocyanate, 1-methyl-naphthalene-1,5-diisocyanate, naphthalene-2,6-diisocyanate, naphthalene-2,7-diisocyanate, 1,1-dinaphthyl-2,2′-diisocyanate, biphenyl-2,4′-diisocyanate, biphenyl-4,4′-diisocyanate, 3,3′-dimethylbiphenyl-4,4′-diisocyanate, diphenylmethane-4,4′-diisocyanate, diphenylmethane-2,2′-diisocyanate, diphenylmethane-2,4-diisocyanate, toluene diisocyanate, and xylylene diisocyanate.

Examples of the cycloaliphatic polyisocyanates include 1,3-cyclopentylene diisocyanate, 1,3-cyclohexylene diisocyanate, 1,4-cyclohexylene diisocyanate, 1,3-bis(isocyanatomethyl)cyclohexane, 1,4-bis(isocyanatomethyl)cyclohexane, lysine diisocyanate, isophorone diisocyanate, 4,4′-dicyclohexylmethane diisocyanate, 2,4′-dicyclohexylmethane diisocyanate, 2,2′-dicyclohexylmethane diisocyanate, and 3,3′-dimethyl-4,4′-dicyclohexylmethane diisocyanate.

When the urethane resin (A1) is produced, the molar ratio [NCO/OH] between the isocyanate groups contained in the polyisocyanate (y) and the hydroxy groups contained in the polyol (x) can be, for example, 0.1 to 5, preferably 0.3 to 3, more preferably 0.4 to 1.5.

The chain extender (z1) is a compound having two or more active hydrogen atoms in one molecule and is typically used for causing an additional reaction with the reaction product of the polyol (x) and the polyisocyanate (y). When the chain extender (z1) further reacts with the reaction product of the polyol (x) and the polyisocyanate (y), a urethane resin having a high molecular weight can be easily obtained.

Examples of the chain extender (z1) include a chain extender having an amino group and a chain extender having a hydroxy group.

Examples of the chain extender having an amino group include ethylenediamine, 1,2-propanediamine, 1,6-hexamethylenediamine, piperazine, 2-methylpiperazine, 2,5-dimethylpiperazine, isophoronediamine, 4,4′-dicyclohexylmethanediamine, 3,3′-dimethyl-4,4′-dicyclohexylmethanediamine, 1,2-cyclohexanediamine, 1,4-cyclohexanediamine, aminoethylethanolamine, hydrazine, diethylenetriamine, and triethylenetetramine.

Examples of the chain extender having a hydroxy group include aliphatic polyols such as ethylene glycol, diethylene glycol, triethylene glycol, propylene glycol, 1,3-propanediol, 1,3-butanediol, 1,4-butanediol, hexamethylene glycol, saccharose, methylene glycol, glycerin, and sorbitol; aromatic polyols such as bisphenol A, 4,4′-dihydroxydiphenyl, 4,4′-dihydroxydiphenyl ether, 4,4′-dihydroxydiphenyl sulfone, hydrogenated bisphenol A, and hydroquinone; and water.

In the case where the chain extender (z1) is contained, the molar ratio [NCO/(H+OH)] between the isocyanate groups contained in the polyisocyanate (y), and the hydroxy groups contained in the polyol (x) and the active hydrogen atoms contained in the chain extender (z1) can be, for example, 0.1 to 5, preferably 0.3 to 3, more preferably 0.4 to 1.

The terminator (z2) is a compound having one active hydrogen atom in one molecule and is typically used for causing an additional reaction with the reaction product of the polyol (x), the polyisocyanate (y), and, as necessary, the chain extender (z1).

Examples of the terminator include alcohols such as hexanol, heptanol, octanol, nonanol, and undecanol; and amines such as dibutylamine.

The amount of the terminator (z1) can be preferably 0.01 parts by mass to 20 parts by mass, more preferably 0.1 parts by mass to 10 parts by mass, with respect to 100 parts by mass of the reaction product of the polyol (x) and the polyisocyanate (y).

The average inter-crosslinking point molecular weight of the urethane resin (A1) can be preferably 9,300 to 30,000, more preferably 9,500 to 27,000, still more preferably 9,500 to 20,000, still more preferably 9,500 to 12,000. The average inter-crosslinking point molecular weight can be understood as the average value of the molecular weight of the molecular chain between two adjacent crosslinking points (branch points). Although it should not be construed as being limited to a specific theory, it is considered that when the inter-crosslinking point molecular weight of the urethane resin (A1) is in such a range, the orientation of the magnetic powder (B) can be changed without restriction when a magnetic field is applied, and a good change in elastic modulus can be obtained.

The average inter-crosslinking point molecular weight can be controlled by the number-average molecular weight of the triol (x1), the number-average molecular weight of the diol (x2) and the amounts of the triol (x1) and the diol (x2) used when the diol (x2) is used, or the like.

In one aspect, the average inter-crosslinking point molecular weight can be calculated on the basis of Formula (1) below, where Mᵢ represents the number-average molecular weight of an i-hydric polyol contained in the polyol (x) and Cᵢ represents the molar fraction of the i-hydric polyol in the total amount of the polyol (x).

$$Average inter - crosslinking point molecular weight = {\sum }_{i = 2}^{n} ( {C}_{i} \times ( 2 {M}_{i} / i ) ) / {\sum }_{i = 3}^{n} ( {C}_{i} \times ( i - 2 ) ) \qquad ( 1 )$$

That is, when a value twice the number obtained by dividing the number-average molecular weight of the polyol by the number of functional groups of the polyol is assumed to be the length of one molecule of the polyol, and a value obtained by subtracting two from the number of functional groups of the polyol is assumed to be the number of crosslinking points contained in the polyol, the total length of the polyol is divided by the total number of crosslinking points in Formula (1) above.

According to the classical theory of rubber, it is considered that in a crosslinked rubber containing no impurities, the inter-crosslinking point molecular weight of the crosslinked rubber correlates with the elastic modulus of the crosslinked rubber. That is, the elastic modulus E (Pa) of the crosslinked rubber is represented by the following formula, where Mc represents the inter-crosslinking point molecular weight of the crosslinked rubber, μ represents the Poisson's ratio of the crosslinked rubber, ρ (g/m³) represents the density of the crosslinked rubber, R (J/(K·mol)) represents the gas constant, and T (K) represents the temperature.

$$E = \frac{2 ( 1 + μ ) ρ RT}{M c}$$

That is, in the crosslinked rubber containing no impurities, the elastic modulus of the crosslinked rubber decreases as the inter-crosslinking point molecular weight increases.

The magnetorheological elastomer composition of the present disclosure contains the magnetic powder (B) in addition to the urethane resin (A1), so that the above formula is considered to be not necessarily applied to the relationship between the average inter-crosslinking point molecular weight of the urethane resin (A1) and the elastic modulus of the magnetorheological elastomer composition, but in the present disclosure, it has been confirmed that a good change in elastic modulus is obtained by setting the number-average molecular weight of the triol (x1) used for producing the urethane resin (A1) to 4,000 or more, which should receive attention.

The urethane resin (A1) can be produced by reacting the polyol (x), the polyisocyanate (y), and as necessary, the chain extender (z1) and the terminator (z2). Such a reaction may be carried out in the absence of a solvent or in the presence of a reaction solvent. The reaction temperature may be 50 to 150° C. Examples of the reaction solvent include ketone solvents such as acetone and methyl ethyl ketone; ether solvents such as tetrahydrofuran and dioxane; acetate ester solvents such as ethyl acetate and butyl acetate; nitrile solvents such as acetonitrile; and amide solvents such as dimethylformamide and N-methylpyrrolidone.

The content of the urethane resin (A1) contained in the resin (A) can be preferably 80 mass % to 100 mass %, more preferably 90 mass % to 100 mass %, still more preferably 95 mass % to 100 mass %.

The content of the urethane resin (A1) contained in the magnetorheological elastomer composition can be, for example, 1 mass % to 50 mass %, preferably 2 mass % to 30 mass, more preferably 3 mass % to 20 mass % in the magnetorheological elastomer composition.

### [Another Resin (A2)]

The resin (A) may further contain another resin (A2) in addition to the urethane resin (A1). Examples of the resin (A2) include an acrylic resin, a polyester resin, a polyamide resin, a polycarbonate resin, and a silicone resin.

### [Magnetic Powder (B)]

The magnetic powder (B) represents a powder of a magnetic substance in which the direction or the magnitude of the magnetic moment can change in response to a change in the external magnetic field. The magnetic substance can typically be a ferromagnetic substance, preferably a soft magnetic substance.

The magnetic substance can be, for example, Fe, or an alloy or oxide containing Fe; preferably Fe, or an alloy or oxide containing Fe and at least one selected from the group consisting of B, C, N, O, Na, Mg, Al, Si, P, S, Cl, K, Ti, V, Cr, Mn, Co, Ni, Cu, Zn, As, Sr, Zr, Nb, Mo, Pd, Sn, Ba, La, Ta, and Bi; more preferably Fe, or an alloy containing Fe and at least one selected from the group consisting of B, Al, Si, Cr, Co, and Ni.

Examples of the magnetic substance include Fe; soft ferrites such as manganese zinc ferrites, nickel zinc ferrites, copper zinc ferrites, and sodium ferrites; and alloys such as FeNi alloys, FeCo alloys, FeSi alloys, FeSiCr alloys, FeSiAl alloys, and FeSiBCr alloys.

The coercive force of the magnetic substance is preferably 100 A/m or less, and the lower limit can be 0 A/m or more.

The saturation magnetic flux density of the magnetic substance may be preferably 0.1 T to 3 T, more preferably 0.5 T to 2.5 T, still more preferably 0.7 T to 2.3 T.

The magnetic permeability of the magnetic substance measured under a magnetic field of 0.002 T may be preferably 0.0001 H/m to 1 H/m, more preferably 0.0005 H/m to 0.1 H/m, still more preferably 0.001 H/m to 0.01 H/m.

The coercive force, saturation magnetic flux density, and magnetic permeability of the magnetic substance represent the coercive force, saturation magnetic flux density, and magnetic permeability measured as a bulk and can be typically measured with a vibrating sample fluxmeter.

The shape of the magnetic powder (B) may be, for example, a spherical shape, a flat shape, a needle shape, or the like, and may typically be a spherical shape.

The magnetic powder (B) may be a powder having an insulating film on a surface thereof. Examples of the insulating film include an inorganic glass film, an organic polymer film, an organic-inorganic hybrid film, and an inorganic insulating film formed by a sol-gel reaction of a metal alkoxide.

The content of the magnetic powder (B) in the magnetorheological elastomer composition of the present disclosure is preferably 25 vol % to 55 vol %, more preferably 35 vol % to 50 vol %, still more preferably 40 vol % to 45 vol %, in 100 vol % in total of the resin (A) and the magnetic powder (B). When the content of the magnetic powder (B) is in such a range, the change in elastic modulus in response to the change in the magnetic field can be improved.

The content of the magnetic powder (B) can be measured by applying heat (500° C. or higher) to the magnetorheological elastomer to evaporate the organic component and measuring the weight of the remaining magnetic powder.

In the magnetorheological elastomer composition of the present disclosure, the total content of the resin (A) and the magnetic powder (B) is preferably 60 mass % to 100 mass %, more preferably 70 mass % to 100 mass %, still more preferably 75 mass % to 100 mass %.

### [Plasticizer (C)]

The magnetorheological elastomer composition of the present disclosure may further contain a plasticizer (C) in addition to the resin (A) and the magnetic powder (B).

Examples of the plasticizer (C) include aromatic dicarboxylic acid plasticizers, aliphatic dicarboxylic acid plasticizers, phosphoric acid plasticizers, and trimellitic acid plasticizers.

Examples of the aromatic dicarboxylic acid plasticizers include phthalate diesters such as dibutyl phthalate, dioctyl phthalate, di-2-ethylhexyl phthalate, diisononyl phthalate, diisodecyl phthalate, diundecyl phthalate, and ditridecyl phthalate; isophthalate diesters such as dioctyl isophthalate and di-2-ethylhexyl isophthalate; and terephthalate diesters such as dioctyl terephthalate and di-2-ethylhexyl terephthalate.

Examples of the aliphatic dicarboxylic acid plasticizers include adipate diesters such as dioctyl adipate, di-2-ethylhexyl adipate, isononyl adipate, and diisodecyl adipate; and sebacate diesters such as dioctyl sebacate, di-2-ethylhexyl sebacate, and diisononyl sebacate.

Examples of the phosphoric acid plasticizers include phosphate esters such as trioctyl phosphate, tri-2-ethylhexyl phosphate, and tricresyl phosphate.

Examples of the trimellitic acid plasticizers include trimellitate triesters such as trioctyl trimellitate and tri-2-ethylhexyl trimellitate; and pyromellitate tetraesters such as tetraoctyl pyromellitate and tetra-2-ethylhexyl pyromellitate.

The plasticizer (C) preferably contains an aromatic dicarboxylic acid plasticizer, more preferably contains a phthalate diester, and particularly preferably contains dioctyl phthalate or di-2-ethylhexyl phthalate.

The content of the plasticizer (C) in the magnetorheological elastomer composition of the present disclosure is preferably 0 parts by mass to 40 parts by mass, more preferably 5 parts by mass to 35 parts by mass, still more preferably 10 parts by mass to 33 parts by mass, with respect to a total of 100 parts by mass of the resin (A) and the magnetic powder (B). When the content of the plasticizer (C) is in such a range, the magnetorheological elastomer composition has a moderate viscosity, and the change in the orientation of the magnetic powder (B) in response to the change in the magnetic field can be improved.

In the magnetorheological elastomer composition of the present disclosure, the total content of the resin (A), the magnetic powder (B), and the plasticizer (C) is preferably 80 mass % to 100 mass %, more preferably 90 mass % to 100 mass %, still more preferably 95 mass % to 100 mass %.

### [Additive (D)]

The magnetorheological elastomer composition of the present disclosure may contain another additive (D) in addition to the resin (A), the magnetic powder (B), and the plasticizer (C) used as necessary. Examples of the additive (D) include a urethanization catalyst, an antioxidant, a light stabilizer, an impact modifier, an antistatic agent, a flame retardant, an antiseptic agent, an ultraviolet absorber, a viscosity modifier, and a colorant.

The urethanization catalyst is used for the reaction of the polyol (x) and the polyisocyanate (y), and is a tin-based compound such as tin octylate, dibutyltin dichloride, dibutyltin oxide, and dibutyltin dilaurate; a titanium-based compound such as dibutyltitanium dichloride, tetrabutyl titanate, and butoxytitanium trichloride; a zinc-based compound such as zinc naphthenate and zinc 2-ethylhexanoate; or a tertiary amine such as triethylamine, triethylenediamine, and 1,8-diazabicyclo-(5,4,0)-undecene-7.

The urethanization catalyst may be 1 part by mass to 10 parts by mass with respect to 100 parts by mass of the urethane resin (A1).

### [Method for Producing Composition]

The magnetorheological elastomer composition of the present disclosure can be produced by mixing the resin (A) and the magnetic powder (B). The mixing of the resin (A) and the magnetic powder (B) may include, for example, mixing the resin (A) and the magnetic powder (B) as it is, and may also include mixing a raw material of the resin (A) and the magnetic powder and then reacting the raw material of the resin (A) to provide the resin (A). When the resin (A) and the magnetic powder (B) are mixed, the urethanization catalyst, the plasticizer (C), and the additive (D) to be used as necessary may appropriately coexist.

Typically, the magnetorheological elastomer composition of the present disclosure can be produced by mixing the polyol (x), the polyisocyanate (y), and the magnetic powder (B) and then heating the mixture to provide a reaction product of the polyol (x) and the polyisocyanate (y). The heating temperature may be 50 to 150° C., and the heating time may be 30 minutes to 20 hours. The heating may be performed in the absence of a solvent or in the presence of a reaction solvent. Examples of the reaction solvent include toluene, acetone, and n-methylpyrrolidone.

The order of mixing the polyol (x), the polyisocyanate (y), and the magnetic powder (B) is not particularly limited. For example, the polyol (x), the polyisocyanate (y), and the magnetic powder (B) may be mixed at the same time, or the polyol (x) and the magnetic powder (B) may be mixed, and then the mixture and the polyisocyanate (y) may be mixed. When the polyol (x), the polyisocyanate (y), and the magnetic powder (B) are mixed, the urethanization catalyst, the resin (A2), the plasticizer (C), and the additive (D) to be used as necessary may appropriately coexist.

In a preferred aspect, the method for producing a magnetorheological elastomer composition of the present disclosure includes: reacting the polyol (x) and the polyisocyanate (y) in the presence of the magnetic powder (B) to provide the magnetorheological elastomer composition, in which the reaction of the polyol (x) and the polyisocyanate (y) is carried out under a magnetic field having a magnetic field strength of more than 0 mT, and the polyol (x) contains the triol (x1) having a number-average molecular weight of 4,000 or more.

According to such a production method, since a magnetic field is applied when the resin (A) is formed by the reaction between the polyol (x) and the polyisocyanate (y), the magnetic powder (B) can be arranged along the lines of magnetic force of the applied magnetic field in the resulting magnetorheological elastomer composition. The orientation of the magnetic powder (B) can also be maintained when the magnetic field is removed after the formation of the magnetorheological elastomer composition. Then, when the magnetic field is applied again along the arrangement direction of the magnetic powder (B), it is considered that the interaction of the magnetic powder (B) can be further strengthened and a higher elastic modulus can be obtained than in the case where the magnetic powder (B) is not arranged. On the other hand, in the absence of a magnetic field, the interaction of the magnetic powder (B) usually does not exist, so that flexibility as an elastomer can be maintained. As a result, in the magnetorheological elastomer composition in which the magnetic powder (B) is oriented, the change in the storage elastic modulus when a magnetic field is applied can be further increased as compared with the storage elastic modulus when a magnetic field is not applied.

The magnetic field strength at the time of reacting the polyol (x) with the polyisocyanate (y) can be preferably 10 mT or more, more preferably 10 mT to 400 mT, still more preferably 20 mT to 350 mT, still more preferably 100 mT to 350 mT.

### [Properties of Composition]

The magnetorheological elastomer composition has viscosity and elasticity.

The storage elastic modulus G′₀ of the magnetorheological elastomer composition measured under zero magnetic field can be preferably 1,000 Pa to 20,000 Pa, more preferably 1,000 Pa to 10,000 Pa, still more preferably 1,000 Pa to 5,000 Pa. When the storage elastic modulus of the magnetorheological elastomer composition is in such a range, a change in elastic modulus when a magnetic field is applied can be improved.

The magnetorheological elastomer composition of the present disclosure may have an increased storage elastic modulus when a magnetic field is applied as compared with when a magnetic field is not applied. Specifically, in one aspect, under the condition of a magnetic field strength of 120,000 A/m, the storage elastic modulus G′₁ measured such that the direction of the magnetic field is parallel to the rotation axis of the rotational viscoelastometer can be preferably 400,000 Pa or more, more preferably 800,000 Pa or more, still more preferably 1,000,000 Pa or more. In another aspect, under the condition of a magnetic field strength of 120,000 A/m, the storage elastic modulus G′₁ measured such that the direction of the magnetic field is parallel to the rotation axis of the rotational viscoelastometer can be preferably 40,000 Pa or more, more preferably 80,000 Pa or more, still more preferably 100,000 Pa or more. When the storage elastic modulus when a magnetic field is applied is in such a range, the propagation velocity of a compressional wave, particularly a sound wave or an ultrasonic wave, passing through the magnetorheological elastomer composition can be increased.

When the rate of change in storage elastic modulus by application of a magnetic field (hereinafter also simply referred to as “rate of change in storage elastic modulus by a magnetic field”) is represented by G′₁/G′₀, the rate of change in storage elastic modulus by the magnetic field of the magnetorheological elastomer composition of the present disclosure is preferably 5 or more, more preferably 20 or more, still more preferably 40 or more, and may be, for example, 300 or less, further 200 or less, or 150 or less. When the rate of change in storage elastic modulus by a magnetic field is in such a range, a compressional wave, particularly a sound wave or an ultrasonic wave, passing through the magnetorheological elastomer composition can be highly deflected. Furthermore, when the storage elastic modulus of the magnetorheological elastomer composition is in the above range and the rate of change in storage elastic modulus by a magnetic field is in the above range, a wide range of elastic modulus can be reproduced by the strength of the applied magnetic field, and the magnetorheological elastomer composition can be preferably used for changing a sound wave or an ultrasonic wave.

The storage elastic modulus of the magnetorheological elastomer composition of the present disclosure can be increased by application of a magnetic field, and the magnetorheological elastomer composition can be suitably used for changing the propagation direction of a compressional wave such as a sound wave, an ultrasonic wave, and an oscillating wave (deflecting the compressional wave). A propagation velocity c (m/s) of the compressional wave is proportional to the square root of the elastic modulus of the propagation medium, and specifically, when the density is denoted by p (kg/m³) and the bulk modulus is denoted by k (Pa), the propagation velocity c (m/s) is represented by Formula (2) below.

$$c = \sqrt{\frac{κ}{ρ}} \qquad ( 2 )$$

Therefore, when the elastic modulus is high, the propagation velocity of the compressional wave is large, and when the elastic modulus is low, the propagation velocity of the compressional wave is small. Although not to be construed as being limited to a particular theory, when a magnetic field is applied to the magnetorheological elastomer composition of the present disclosure, the increase in storage elastic modulus correlates with the direction of the magnetic field, and typically the storage elastic modulus increases in a direction parallel to the direction of the magnetic field. Therefore, it is considered that as a result of anisotropy of the storage elastic modulus caused by the application of a magnetic field, the propagation direction of the compressional wave can change.

The magnetorheological elastomer composition of the present disclosure is preferably used to deflect sound waves or ultrasonic waves, and is suitably used particularly in acoustic devices such as loudspeakers; and ultrasonic devices such as ultrasonic sensors. In addition, the magnetorheological elastomer composition of the present disclosure can be used for a haptic feedback device using a change in elastic modulus.

The present disclosure includes the following.
[1] A magnetorheological elastomer composition including: a resin (A) and a magnetic powder (B), in which the resin (A) contains a urethane resin (A1), the urethane resin (A1) contains a reaction product of a polyol (x) and a polyisocyanate (y), and the polyol (x) contains a triol (x1) having a number-average molecular weight of 4,000 or more.
[2] The magnetorheological elastomer composition according to [1], in which the urethane resin (A1) has an average inter-crosslinking point molecular weight of 9,500 to 27,000.
[3] The magnetorheological elastomer composition according to [1] or [2], in which a content of the magnetic powder (B) is 25 vol % to 55 vol % with respect to 100 vol % in total of the resin (A) and the magnetic powder (B).
[4] The magnetorheological elastomer composition according to any one of [1] to [3], further including a plasticizer (C), in which the plasticizer (C) includes an aromatic dicarboxylic acid plasticizer.
[5] A method for producing a magnetorheological elastomer composition, including: reacting a polyol (x) and a polyisocyanate (y) in the presence of a magnetic powder (B) to provide a magnetorheological elastomer composition, in which the reaction of the polyol (x) and the polyisocyanate (y) is carried out under a magnetic field having a magnetic field strength of more than 0 mT, and the polyol (x) contains a triol (x1) having a number-average molecular weight of 4,000 or more.
[6] A magnetorheological elastomer composition obtained by a reaction of a polyol (x) and a polyisocyanate (y) in the presence of a magnetic powder (B), in which the reaction of the polyol (x) and the polyisocyanate (y) is carried out under a magnetic field having a magnetic field strength of more than 0 mT, and the polyol (x) contains a triol (x1) having a number-average molecular weight of 4,000 or more.

### EXAMPLES

The present disclosure will be more specifically described with reference to the following examples, but the present disclosure is not limited thereto.

### Experimental Example 1

In a reaction vessel, 1.64 parts by mass of polypropylene triol having a number-average molecular weight of 3,000, 3.39 parts by mass of polypropylene diol having a number-average molecular weight of 3,000, 0.45 parts by mass of tolylene diisocyanate as the polyisocyanate (y), 70.9 parts by mass of a FeSiCr powder having a particle size of 3 μm as the magnetic powder (B), and 22.8 parts by mass of dioctyl phthalate as the plasticizer (C) were put and mixed. Then, 0.4 parts by mass of tin octylate as the urethanization catalyst was added to the mixture, and the mixture was further mixed and then stirred at 2,000 rpm for 390 seconds using a defoaming stirrer to provide a paste. The obtained paste was heated at 75° C. for 2 hours using a hot plate and thermally cured to provide a magnetorheological elastomer (MRE) composition.

### Experimental Examples 2 to 9

A magnetorheological elastomer composition was obtained in the same manner as in Experimental Example 1 except that the number-average molecular weights (Mn) and the use amounts of the triol and the diol, and the use amounts of the magnetic powder (B) and the plasticizer (C) were changed as shown in Tables 1 and 2.

### Experimental Examples 10 to 14

In a reaction vessel, 2.07 parts by mass of polypropylene triol having a number-average molecular weight of 4,000, 3.63 parts by mass of polypropylene diol having a number-average molecular weight of 3,000, 0.45 parts by mass of tolylene diisocyanate as the polyisocyanate (y), 70.9 parts by mass of a FeSiCr powder having a particle size of 3 μm as the magnetic powder (B), and 22.8 parts by mass of dioctyl phthalate as the plasticizer (C) were put and mixed. Then, 0.4 parts by mass of tin octylate as the urethanization catalyst was added to the mixture, and the mixture was further mixed and then stirred at 2,000 rpm for 390 seconds using a defoaming stirrer to provide a paste. The obtained paste was heated at 75° C. for 2 hours using a hot plate while a magnetic field was applied under the conditions shown in Table 2 and thermally cured to provide a magnetorheological elastomer (MRE) composition.

The following measurement was performed on the magnetorheological elastomer compositions of Experimental Examples 1 to 14.

### [Method for Measuring Storage Elastic Modulus]

The magnetorheological elastomer composition was molded into a disk shape having a diameter of 2 cm and a thickness of 1 mm and used as a sample. Next, the sample was set in a viscoelastometer (model: MCR301, manufactured by Anton Paar GmbH), and the storage elastic moduli when a magnetic field was not applied and when a magnetic field was applied were measured using a magnetic field generator (model: PS-MRD, manufactured by Anton Paar GmbH). The measurement was performed such that the rotation axis of the viscoelastometer and the direction of the magnetic field were parallel to each other.

### (Conditions During Viscoelasticity Measurement)

Measurement temperature: 25° C.
Load applied from terminal to sample: 0.3 N
Frequency: 1 Hz
Strain: 0.01%
Magnetic field strength when magnetic field is applied: 150 mT

Tables 1 and 2 show the results. Among Experimental Examples 1 to 17 in Tables 1 and 2, those corresponding to comparative examples of the present disclosure are denoted by the symbol “*”, and the others correspond to examples of the present disclosure.

TABLE 1

| | | | | | 1 * | 2 | 3 | 4 | 5 | 6 | 7* | 8 | 9 |
|---|---|---|---|---|---|---|---|---|---|---|---|---|---|
| Resin (A) | (x) | Triol | Mn | Parts | 1.45 | | | | | | 1.45 | | |
| | | | 3,000 | by | | | | | | | | | |
| | | | | mass | | | | | | | | | |
| | | | Mn | Parts | | 1.94 | 2.07 | 2.07 | 2.07 | 2.07 | | | |
| | | | 4,000 | by | | | | | | | | | |
| | | | | mass | | | | | | | | | |
| | | | Mn | Parts | | | | | | | | 3.11 | |
| | | | 6,000 | by | | | | | | | | | |
| | | | | mass | | | | | | | | | |
| | | | Mn | Parts | | | | | | | | | 5.18 |
| | | | 10,000 | by | | | | | | | | | |
| | | | | mass | | | | | | | | | |
| | | Diol | Mn | Parts | 3.39 | 3.39 | | 3.63 | 3.63 | | 3.39 | | |
| | | | 3,000 | by | | | | | | | | | |
| | | | | mass | | | | | | | | | |
| | | | Mn | Parts | | | 4.84 | | | | | | |
| | | | 4,000 | by | | | | | | | | | |
| | | | | mass | | | | | | | | | |
| | | | Mn | Parts | | | | | | | | 7.26 | |
| | | | 6,000 | by | | | | | | | | | |
| | | | | mass | | | | | | | | | |
| | | | Mn | Parts | | | | | | 12.10 | | | 12.10 |
| | | | 10,000 | by | | | | | | | | | |
| | | | | mass | | | | | | | | | |
| | (y) | Tolylene | | Parts | 0.45 | 0.45 | 0.45 | 0.45 | 0.45 | 0.45 | 0.45 | 0.45 | 0.45 |
| | | diisocyanate | | by | | | | | | | | | |
| | | | | mass | | | | | | | | | |
| | Average inter- | | | | 9,000 | 9,667 | 12,000 | 9,667 | 9,667 | 26,000 | 9,000 | 18,000 | 30,000 |
| | crosslinking | | | | | | | | | | | | |
| | point molecular | | | | | | | | | | | | |
| | weight | | | | | | | | | | | | |
| Magnetic | FeSiCr powder | | | Parts | 70.9 | 73.9 | 73.9 | 165 | 123.5 | 123.5 | 130 | 85 | 100 |
| powder (B) | | | | by | | | | | | | | | |
| | | | | mass | | | | | | | | | |
| | Volume fraction | | | Vol % | 25 | 25 | 25 | 43 | 36 | 36 | 38 | 25 | 25 |
| Plasticizer | Dioctyl phthalate | | | Parts | 22.8 | 22.8 | 22.8 | 22.8 | 22.8 | 22.8 | 22.8 | 22.8 | 22.8 |
| (C) | | | | by | | | | | | | | | |
| | | | | mass | | | | | | | | | |

| | | | | | | | | | | |
|---|---|---|---|---|---|---|---|---|---|---|
| Evaluation | Change in elastic | 30 | 86 | 76 | 123 | 130 | 83 | 42 | 35 | 37 |
| results | modulus | | | | | | | | | |

Experimental Examples 2 to 6, 8, and 9 are examples of the present disclosure, and the change in storage elastic modulus when a magnetic field was applied was larger than the storage elastic modulus when a magnetic field was not applied.

Experimental Examples 1 and 7 are examples not containing a triol having a number-average molecular weight of 4,000 or more, and the change in storage elastic modulus when a magnetic field was applied was not sufficiently satisfactory.

TABLE 2

| | | | | | 10 | 11 | 12 | 13 | 14 |
|---|---|---|---|---|---|---|---|---|---|
| Resin (A) | (x) | Triol | Mn 3,000 | Parts | | | | | |
| | | | | by mass | | | | | |
| | | | Mn 4,000 | Parts | 2.07 | 2.07 | 2.07 | 2.07 | 2.07 |
| | | | | by mass | | | | | |
| | | | Mn 6,000 | Parts | | | | | |
| | | | | by mass | | | | | |
| | | | Mn 10,000 | Parts | | | | | |
| | | | | by mass | | | | | |
| | | Diol | Mn 3,000 | Parts | 3.63 | 3.63 | 3.63 | 3.63 | 3.63 |
| | | | | by mass | | | | | |
| | | | Mn 4,000 | Parts | | | | | |
| | | | | by mass | | | | | |
| | | | Mn 6,000 | Parts | | | | | |
| | | | | by mass | | | | | |
| | | | Mn 10,000 | Parts | | | | | |
| | | | | by mass | | | | | |

| | | | | | | | |
|---|---|---|---|---|---|---|---|
| (y) | Tolylene diisocyanate | Parts | 0.45 | 0.45 | 0.45 | 0.45 | 0.45 |
| | | by mass | | | | | |

| | | | | | | | |
|---|---|---|---|---|---|---|---|
| | Average inter-crosslinking | | 9,667 | 9,667 | 9,667 | 9,667 | 9,667 |
| | point molecular weight | | | | | | |
| Magnetic | FeSiCr powder | Parts | 70.9 | 70.9 | 70.9 | 70.9 | 70.9 |
| powder (B) | | by mass | | | | | |
| | Volume fraction | Vol % | 25 | 25 | 25 | 25 | 25 |
| Plasticizer (C) | Dioctyl phthalate | Parts | 22.8 | 22.8 | 22.8 | 22.8 | 22.8 |
| | | by mass | | | | | |
| Applied | Magnetic field | mT | 0 | 20 | 150 | 300 | 500 |
| magnetic field | strength | | | | | | |
| Evaluation | Elastic modulus (applied | kPa | 4 | 4.3 | 5.2 | 6.3 | 10 |
| results | magnetic field: 0 mT) | | | | | | |
| | Elastic modulus (applied | kPa | 520 | 667 | 900 | 1,134 | 1,130 |
| | magnetic field: 150 mT) | | | | | | |
| | Change in elastic modulus | Times | 130 | 155 | 173 | 180 | 113 |

Examples 10 to 14 are examples in which the reaction of the polyol (x) and the polyisocyanate (y) was performed under a magnetic field having a magnetic field strength of 20 to 500 mT, and the obtained magnetorheological elastomer composition had a high storage elastic modulus when a magnetic field was applied, and showed a good change in elastic modulus. The storage elastic modulus of the resin (A) alone is 3.0 kPa, and it is considered that since the magnetorheological elastomer composition of the present disclosure contains the resin (A) having high flexibility, the change in arrangement of the magnetic powder (B) is hardly hindered, and a large change in elastic modulus can be obtained.

1. A magnetorheological elastomer composition comprising:
a resin (A);
a magnetic powder (B); and
a plasticizer (C), wherein
the resin (A) contains a urethane resin (A1),
the urethane resin (A1) contains a reaction product of a polyol (x) and a polyisocyanate (y),
the polyol (x) contains:
a triol (x1) having a number-average molecular weight of 4,000 or more; and
a diol (x2),
the triol (x1) contains polypropylene triol,
the diol (x2) contains a polyether diol excluding an aromatic ring,
the polyether diol contains polypropylene diol,
the plasticizer (C) contains an aromatic dicarboxylic acid plasticizer, and
the urethane resin (A1) has an average inter-crosslinking point molecular weight of 9,500 to 27,000.

2. The magnetorheological elastomer composition according to claim 1, wherein a content of the magnetic powder (B) is 25 vol % to 55 vol % with respect to 100 vol % in total of the resin (A) and the magnetic powder (B).

3. The magnetorheological elastomer composition according to claim 1, wherein the number-average molecular weight of the triol (x1) is 4,000 to 15,000.

4. The magnetorheological elastomer composition according to claim 1, wherein a number-average molecular weight of the diol (x2) is more than 300.

5. The magnetorheological elastomer composition according to claim 1, wherein a content of the triol (x1) in the polyol (x) is 3 mass % or more.

6. The magnetorheological elastomer composition according to claim 1, wherein a content of the diol (x2) in the polyol (x) is 50 parts by mass to 2,000 parts by mass with respect to 100 parts by mass of the triol (x1).

7. The magnetorheological elastomer composition according to claim 1, wherein a total content of the triol (x1) and the diol (x2) in 100 mass % of the polyol (x) is 80 mass % to 100 mass %.

8. The magnetorheological elastomer composition according to claim 1, wherein the polyisocyanate (y) is one or more of aliphatic polyisocyanates, aromatic polyisocyanates, and cycloaliphatic polyisocyanates.

9. The magnetorheological elastomer composition according to claim 1, wherein the average inter-crosslinking point molecular weight of the urethane resin (A1) is 9,500 to 20,000.

10. The magnetorheological elastomer composition according to claim 1, wherein the average inter-crosslinking point molecular weight of the urethane resin (A1) is 9,500 to 12,000.

11. A method for producing a magnetorheological elastomer composition, the method comprising:
reacting a polyol (x) and a polyisocyanate (y) in presence of a magnetic powder (B) under a magnetic field having a magnetic field strength of more than 0 mT to produce a magnetorheological elastomer composition containing a urethane resin (A1) having an average inter-crosslinking point molecular weight of 9,500 to 27,000, wherein
the polyol (x) contains:
a triol (x1) having a number-average molecular weight of 4,000 or more; and
a diol (x2),
the triol (x1) contains polypropylene triol,
the diol (x2) contains a polyether diol excluding an aromatic ring, and
the polyether diol contains polypropylene diol.

12. The method for producing a magnetorheological elastomer composition according to claim 11, wherein the number-average molecular weight of the triol (x1) is 4,000 to 15,000.

13. The method for producing a magnetorheological elastomer composition according to claim 11, wherein a number-average molecular weight of the diol (x2) is more than 300.

14. The method for producing a magnetorheological elastomer composition according to claim 11, wherein a content of the triol (x1) in the polyol (x) is 3 mass % or more.

15. The method for producing a magnetorheological elastomer composition according to claim 11, wherein a content of the diol (x2) in the polyol (x) is 50 parts by mass to 2,000 parts by mass with respect to 100 parts by mass of the triol (x1).

16. The method for producing a magnetorheological elastomer composition according to claim 11, wherein a total content of the triol (x1) and the diol (x2) in 100 mass % of the polyol (x) is 80 mass % to 100 mass %.

17. The method for producing a magnetorheological elastomer composition according to claim 11, wherein the polyisocyanate (y) is one or more of aliphatic polyisocyanates, aromatic polyisocyanates, and cycloaliphatic polyisocyanates.

18. The method for producing a magnetorheological elastomer composition according to claim 11, wherein the average inter-crosslinking point molecular weight of the urethane resin (A1) is 9,500 to 20,000.

19. The method for producing a magnetorheological elastomer composition according to claim 11, wherein the average inter-crosslinking point molecular weight of the urethane resin (A1) is 9,500 to 12,000.

20. The method for producing a magnetorheological elastomer composition according to claim 11, wherein the magnetic field strength is 10 mT or more.
